(19) United States
(12) Patent Application Publication
(10) Pub. No.: US 2011/0191787 A1
(43) Pub. Date: Aug. 4, 2011

(54) SYSTEM AND METHOD FOR PROVIDING SENSOR DATA FROM EMBEDDED DEVICE TO SOFTWARE DEVELOPMENT ENVIRONMENT

(75) Inventors: Oren Poleg, Tel Aviv (IL); Omer Pomerantz, Herzlia (IL)

(73) Assignee: SUN MICROSYSTEMS, INC., Santa Clara, CA (US)

(21) Appl. No.: 12/698,305

(22) Filed: Feb. 2, 2010

(51) Int. Cl. G06F 9/44

(52) U.S. Cl. 719/328; 717/100

(57) ABSTRACT

A system and method for providing device data for use in developing application software for a microprocessor-based embedded device having at least one physical sensor using a software development environment include an agent executing on the target embedded device and a connectivity module executing within the software development environment to communicate sensor data from the embedded device to the software development environment. In one embodiment, the target device is a mobile phone that provides sensor data from an integrated physical sensor to a development computer executing mobile phone software within the development environment using the same API's within the development environment as used on the embedded device.

### TECHNICAL FIELD

The present disclosure relates to a system and method for providing sensor data from an embedded device to a software development platform for use in developing embedded device software applications that use the sensor data.

### BACKGROUND

An embedded device or system generally refers to a special purpose computing system designed to perform a specific function, often with real-time computing constraints. The computing system or platform, including a microprocessor, memory, I/O, and the like is embedded with associated hardware and mechanical parts related to the function of the device. For example, embedded devices may include mobile phones, smart phones, PDAs and related devices, digital cameras, television set-top boxes, smart appliances, stereos, digital televisions, etc. In contrast, general purpose computers or personal computers may contain similar components including a microprocessor, memory, I/O, etc, but are designed to be more flexible to meet a wider variety of uses.

Software application development for embedded devices typically uses a general purpose computer having significant resources including processor capabilities, memory, and persistent storage to develop application programs for various computing platforms, which may have similar, or significantly different resources available. For example, application development for embedded devices such as mobile phones or television set-top boxes, may use development tools provided in a Software Development Kit (SDK) such as compilers, libraries, and various support files within an Integrated Development Environment (IDE) that has a user interface, text editor, debugger (in some cases), build tools, file management utilities, etc running on a personal computer workstation.

Due to the more limited resources available in many embedded devices, application program development for these devices presents challenges not encountered when developing applications for a target computing platform having resources similar to those of the IDE workstation. In particular, for sensor-enabled applications targeted for a personal computer, for example, the development environment runs on the same type of machine with similar resources as the target machine. In this case, actual sensors can be connected to the IDE workstation and used during the development cycle to test the operation of the application software. With embedded devices, the development environment may have significantly more resources available than the target machine. For these applications, the development cycle may include one of the following, for example: a) develop on workstation, debug on mobile device using device sensor(s), run/test on mobile device, or b) develop on workstation, debug on workstation using sensor emulator/simulator, and run/test on mobile device with device sensor(s). While option “a” may be more desirable than option “b”, most developers would prefer to develop applications on the IDE workstation while being able to use actual sensor data to significantly reduce development time and improve efficiency.

Various development environments use emulation techniques to allow the use of a common workstation which runs the development suite (IDE) to develop applications for various types of computing platforms. The application code is developed on the workstation, tested on the workstation in the emulation or simulation environment, and is then loaded for testing and deployment on the target embedded device. Currently available tools in the industry work in this manner, including Microsoft Visual Studio™, IBM's Eclipse™, Sun Microsystem's Netbeans™, and many more. However, various features of embedded/mobile devices, such as physical sensor output and unique device capabilities, are difficult to accurately simulate or emulate. Software simulators often have deficiencies in simulating various types of sensory input, such as multi-touch or gesture input from a touch pad or global positioning system (GPS) location data, for example. As such, deployment to the actual device may be necessary to identify any programming issues associated with these sensors or features. Without the ability to use real sensor data, development time is much longer and there is limited ability for software verification.

### SUMMARY

A system and method for providing sensor data from an embedded device to a development computer running a software development environment include communicating sensor data from the embedded device having a microprocessor in communication with at least one sensor associated with the device to the software development environment of the development computer. The system and method may also include communicating control data from the embedded device application software executing within the software development environment of the development computer to the embedded device.

In one embodiment, the embedded device is a mobile phone having at least one physical sensor, such as a location or GPS sensor, touch sensor, camera, and/or motion sensor, and the system and method include an agent executed by the embedded device microprocessor that communicates associated sensor data to a development environment of a development computer using a standard protocol, such as TCP/IP or HTTP, for example. Other embodiments include a sensor or secondary embedded device in communication with the primary embedded device with the agent communicating data associated with the secondary sensor or embedded device to the development environment. In one embodiment, the mobile device is a mobile phone with the agent implemented in the JavaME™ programming language and communicating sensor data from a mobile phone to the JavaME™ Software Development Kit (SDK) running within the NetBeans™ Integrated Development Environment (IDE) on a development computer.

Embodiments according to the present disclosure provide various advantages. For example, embodiments of the present disclosure provide actual sensor data for any kind of sensor associated with a target embedded device that is accessible in the form of a software API to the development environment to eliminate the need for sensor simulators for testing or debugging embedded device applications within the IDE. In particular, various embodiments enable the application program being developed to use the exact same API calls within the SDK that will be used on the target device, so the mechanism for obtaining sensor data is completely transparent to the application program being developed within the IDE. A generic agent operating on the embedded device communicates sensor information from device sensors to the development environment. Sensor data from the target embedded device may be communicated in response to a request from the application program running within the IDE using a “pull” model, and/or may be communicated in response to an event or change in status of data as detected by the embedded device using a “push” model. This provides flexibility in obtaining any kind of actual sensor data that is available on the target device using the same generic agent code. Use of an attached or linked embedded device with actual real-time or near real-time sensor data according to embodiments of the present disclosure greatly enhances the ability of the developer to test and verify code within the development environment on the development computer, which may improve productivity and reduce development time while improving the robustness of the deployed embedded device applications. In addition, a system or method according to the present disclosure may be used in a number of applications to provide development environment access to sensor output from virtually any type of sensor used in an embedded device capable of sending the sensor data over a communication link without modification of the embedded device or custom device feature/sensor simulators. The embedded device used to provide sensor data to the development environment is not necessarily the device for which the application software is being developed, which allows development and testing of the application software when the intended target embedded device is unavailable. Similarly, embodiments of the present disclosure do not require that the same programming language for the application being developed within the development environment be used for the agent that communicates sensor and/or control data from the embedded device to the development environment.

The above advantages and other advantages and features will be readily apparent from the following detailed description of the preferred embodiments when taken in connection with the accompanying drawings.

### BRIEF DESCRIPTION OF THE DRAWINGS

FIG. 1 is a block diagram illustrating a system or method for providing sensor data from a mobile device to a development environment according to one embodiment of the present disclosure; and

FIG. 2 is a flowchart illustrating operation of a system or method for providing sensor data from a mobile device to a development environment according to one embodiment of the present disclosure.

### DETAILED DESCRIPTION

As those of ordinary skill in the art will understand, various features illustrated and described with reference to any one of the Figures may be combined with features illustrated in one or more other Figures to produce embodiments that are not explicitly illustrated or described. The combinations of features illustrated provide representative embodiments for representative applications. However, various combinations and modifications of the features consistent with the teachings of this disclosure may be desired for particular applications or implementations.

Systems and methods according to the present disclosure are illustrated and described with respect to representative embodiments in the block diagrams and flow charts of the Figures. Various operations or functions may be performed in hardware and/or software depending on the particular application and implementation, and independent of the implementation illustrated and described with respect to any particular embodiment. The strategy and/or logic illustrated is generally stored as instructions or code implemented by software and related hardware. Code may be processed using any of a number of known strategies such as event-driven, interrupt-driven, multi-tasking, multi-threading, and the like. Similarly, multiple instances may be separately executed by a single processor, by two or more processors in a single machine, or processing may be distributed across two or more machines. As such, various steps or functions illustrated may be performed in the sequence illustrated, in parallel, in a different sequence, or in some cases omitted. Although not explicitly illustrated, one of ordinary skill in the art will recognize that one or more of the illustrated functions may be repeatedly performed depending upon the particular processing strategy being used. Similarly, the order of processing is not necessarily required to achieve the features and advantages described herein, but is provided for ease of illustration and description. Preferably, the control logic or code represented in the Figures is implemented primarily in software with instructions executed by one or more microprocessors. When implemented in software, the control logic may be provided in one or more computer-readable storage media having stored data representing code or instructions executed by a computer. The computer-readable storage media may include one or more of a number of known physical devices which utilize electric, magnetic, optical, and/or hybrid storage to keep source code and/or executable instructions and associated information.

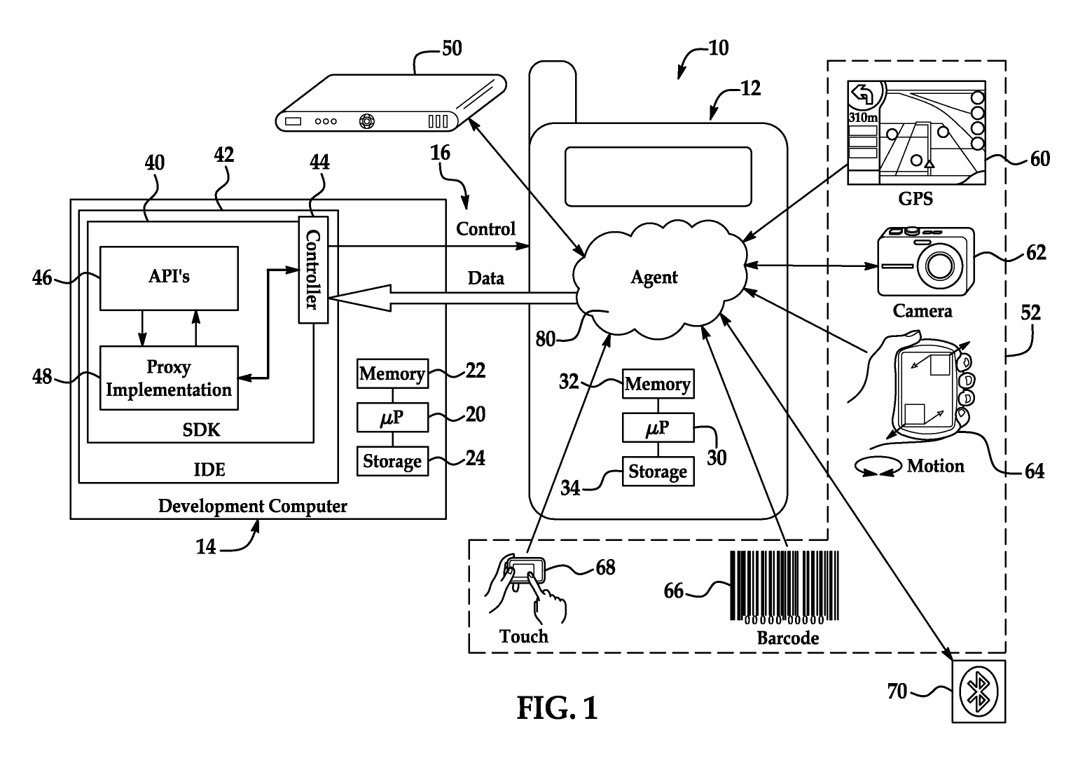

FIG. 1 is a block diagram illustrating a system or method for providing actual sensor data from an embedded device to a development environment according to one embodiment of the present disclosure. As used herein, actual sensor data refers to data generated by a physical sensor in contrast to data generated by a sensor simulator or emulator. System 10 includes an embedded device 12 and a general purpose development computer 14 that exchange information over a wired or wireless communication link 16. Information exchanged via communication link 16 may include control/command information generated by an embedded device application program running within the development environment of computer 14, as well as actual sensor data obtained from one or more sensors associated with embedded device 12. As described in greater detail herein, embedded device 12 functions as an attached device to development computer 14 so that the actual sensor data from embedded device 12 can be used by the embedded device application running within the development environment on computer 14. As such, the developer is not required to download and run the embedded device application program on the intended target embedded device for testing interaction with sensor data or various device-specific functions common to the intended target embedded device and attached embedded device 12. Instead, sensor-related and device-specific testing and debugging can be performed using the more powerful resources of general purpose development computer 14 and the tools provided within the development environment. Moreover, the application being developed and running within the development environment is unaware of the fact that the sensory data are being relayed to the application and not provided directly or natively from the intended target device as the application uses the same API calls within the development environment as used when running on the intended target device.

As described above, it should be appreciated that embedded device 12 may be, but is not necessarily, the intended target device for which the application software is being developed on computer 14. An embedded device 12 having one or more of the same or similar type of sensors, or the same or similar type of device functionality, as the intended target device can be used to provide sensor data to the development environment of computer 14. As such, the API calls used within the development environment are the same as the API calls that will be used on the intended target device, but may be different from the API calls used on embedded device 12 to provide sensor data to the development environment. This allows use of actual sensor data provided by embedded device 12 where the intended target device is not available, for example. It should also be appreciated that more than one embedded device 12 may be used to provide various types of sensor data that would otherwise be available from a single intended target device.

In the representative embodiment illustrated in FIG. 1, embedded device 12 is a mobile device, such as a mobile phone, PDA, or similar device. However, those of ordinary skill in the art will recognize that systems and methods of the present disclosure may be used to provide sensor data from any type of embedded device 12, which includes mobile, hand-held devices such as phones, PDAs, cameras, and the like, as well as larger, less mobile devices, such as television set top boxes/units, smart appliances, stereos, digital televisions, and many others. Similarly, embedded devices may include a wide variety of sensors that provide a corresponding wide variety of data. As used herein, sensors may include devices such as location or GPS sensors, motion sensors, touch/multi-touch sensors, user interface (UI) input devices (such as keyboard, joystick, dials and other device buttons), cameras (including photo/video/audio capture), Bluetooth data and communication devices, infrared (IR) receivers/transceivers, barcode scanners/readers, compass, bio-sensors (such as blood pressure, pulse, etc.), light sensors, acoustic sensors and ultra-sound sensors, temperature sensors, internal component sensors (such as battery level, radio signal quality, etc.), humidity sensors, gyroscopes, and many more.

Embedded device 12 and development computer 14 are both microprocessor-based computing devices that include hardware, such as one or more microprocessors 20, 30, memory 22, 32, and persistent computer readable storage medium 24, 34, and software, represented by Software Development Kit (SDK) 40, Integrated Development Environment (IDE) 42, controller module 44, proxy implementation 48, and agent 80. Those of ordinary skill in the art will appreciate that, although embedded device 12 and development computer 14 are both microprocessor-based computing devices, each typically has significantly different resources available. For example, development computer 14 is typically a general purpose personal computer, such as a laptop or workstation, with high-speed, full-feature microprocessor(s), significant local disk storage, memory, etc. whereas embedded device 12 has a specialized, low-power microprocessor with an associated limited instruction set, much less memory, smaller persistent storage, etc. As such, development of application software for mobile device 12 is facilitated by use of SDK 40 and/or IDE 42 that emulate the features and capabilities of mobile device 12 for testing and debugging purposes. However, simulation or emulation of hardware sensor data has various disadvantages as previously described. As such, embodiments of the present disclosure provide a system and method for communicating actual data associated with physical hardware sensors integrated within or linked to embedded device 12 for use within the development environment represented by SDK 40 and/or IDE 42.

As shown in FIG. 1, embedded device 12 may also include one or more hardware sensors 52 in direct or indirect communication with microprocessor 30. Of course, the system and method for providing sensor data to the development environment according to the present disclosure is independent of the particular type of sensor or sensor data associated with embedded device 12 and/or the intended target device, and the number and type of sensors may vary by application. In the representative embodiment illustrated, physical sensors 52 may include a location (or GPS) sensor 60, camera 62, motion sensor 64, optical/barcode sensor 66, and touch/multi-touch sensor 68, for example. Sensors 52 may be integrated within a common housing of embedded device 12, but are shown separately only for ease of illustration. Embedded device 12 may also be temporarily or persistently linked to one or more secondary embedded devices and/or remote sensors, as generally represented by set top box/unit (STB/STU) 50 and wireless devices 70. The link may be implemented via a wired or wireless connection using a corresponding communication protocol, such as Bluetooth or Wi-Fi, for example. Linked devices 50, 70 are external devices relative to embedded device 12, but may also provide sensor data to development computer 14 via embedded device 12. Linked devices 50, 70 may include input devices, such as a keyboard, keypad, infrared (IR) receiver, or microphone, as well as output devices, such as an earphone, for example. As explained in greater detail herein, one of the advantages of a system or method for providing actual sensor data to a development environment according to the present disclosure is the ability to use the actual communication protocol stack managed by embedded device 12 in communicating with linked devices 50, 70 to identify or detect any limitations or anomalies associated with the embedded device communication link(s). This facilitates accommodating the limitations of the embedded device during the development cycle before general release and deployment of any applications.

Embedded device 12 includes a module or agent 80 executed by microprocessor 30 to communicate sensor data from integrated physical sensors 52 and/or linked device(s) 50, 70 to the development environment of development computer 14, as represented by SDK 40 and IDE 42. In one embodiment, agent 80 uses available application programming interfaces (API's) of linked/attached embedded device 12 to access sensor data from hardware sensors 52 and any linked/attached secondary device 50, 70. Similarly, agent 80 may use associated API's of linked/attached embedded device to control or manage various integrated hardware sensors 52 and attached secondary devices 50, 70 in response to requests or commands generated by the target embedded device application program running within IDE 42 on development computer 14 and communicated to agent 80 via proxy implementation 48 and controller 44 over communication link 16, which may be implemented by a wired or wireless communication link. As shown in FIG. 1, the application program running within IDE 42 uses APIs 46 that are the same as the APIs for the target embedded device.

As previously described, the target device may be, but is not necessarily, the same as the attached/linked embedded device 12. Where the target device and embedded device 12 are different, the API being used in the SDK 40 for acquiring sensor data by the application being developed for the intended target device is not necessarily present on the attached embedded device 12. In this case, agent 80 acts as an interface using available API's for embedded device 12 to acquire data from integrated sensors 52 and/or sensors associated with any linked secondary devices 50,70 and provide sensor data to the development environment in response to API calls for the corresponding intended target device. Similarly, the programming language of the application being developed in SDK 40 may be, but is not necessarily, the same as the programming language of agent 80. However, in either case, a proxy implementation 48 is provided to relay sensor data and/or control information between agent 80 on embedded device 12 and SDK 40 of development computer 14 via controller 44.

Agent 80 and controller 44 may communicate sensor data and/or control information using a standard or proprietary data transfer protocol. In one embodiment, sensor data from embedded hardware sensors 52 and/or linked device(s) 50, 70 are communicated using a standard network protocol with a pre-defined data structure, as is typical with distributed computer programs. Representative networking communication protocols may include TCP/IP and HTTP, for example. However, those of ordinary skill in the art will recognize that the system and method for communicating sensor and control data between embedded device 12 and development computer 14 are independent of the particular protocols, data structures, or programming paradigms used to communicate the information, which may vary by application and implementation. For example, the systems and methods of providing sensor data from an embedded device to a development environment according to the present disclosure may use a data pull paradigm where sensor data is requested by a call to API 46 within SDK 40 on development computer 14 and/or a data push paradigm where agent 80 initiates sending sensor data to development computer 14 in response to a trigger event, such as a change in sensor data or device status.

As those of ordinary skill in the art will recognize, embedded device 12 may be linked to devices 50, 70 that may or may not include an agent 80, and the communications functions of device 12 can often be tested without a corresponding agent on a linked device 50, 70. In some instances, linked devices 50, 70 may not be capable of running agent 80, while in other instances, linked devices 50, 70 may be identical to embedded device 12. In either case, an agent is generally not required to run on the linked device to provide sensor data from that device to agent 80 running on embedded device 12 for use by the application running on development compute 14. Rather, agent 80 uses the appropriate API's for embedded device 12 to acquire the sensor data from any linked device(s). For example, embedded device 12 may be implemented by a mobile phone with a linked device 70 implemented by a wireless keyboard communicating with embedded device 12 via the Bluetooth™ protocol. Alternatively, embedded device 12 may be implemented by a set top box and communicate with a secondary set top box 50 via a wired USB or TCP/IP link

In operation, embedded device 12 is attached to general purpose development computer 14 via a wireless or wired communication link 16. Agent 80 may be downloaded to embedded device 12 from development computer 14 over communication link 16, or may be transferred to embedded device 12 in any other conventional manner. Similarly, controller 44 is installed and initiated on development computer 14 as an interface or relay between proxy implementation 48 of the development environment represented by SDK 40 and IDE 42, and agent 80 of mobile device 12. More specifically, the target embedded device application written and running on the SDK will use the same APIs 46 as the application running on an actual target embedded device, which may be, but is not necessarily, the same as embedded device 12 as previously described. The primary difference is within proxy implementation 48 of the API 46, which instead of using the sensors directly, will forward sensor data requests to agent 80 running on mobile device 12 via controller 44. Agent 80 uses available API's of embedded device 12 to capture sensor data associated with one or more integrated hardware sensors 52 and/or attached secondary embedded device 50 and/or wireless device 70 and communicates the data to controller 44 over communications link 16 using a standard protocol. Controller 44 then passes the received sensor data to proxy implementation 48 on SDK 40, which will send the information representing the actual physical sensor data to the embedded device application program running within IDE 42 of development computer 14, using the sensor APIs of embedded device 12. Similarly, the embedded device application program running within IDE 42 of development computer 14 may generate various sensor/device control commands/requests that are communicated by controller 44 to agent 80 over communication link 16 using a standard protocol. Control commands/requests may be used to access various embedded device-specific or sensor-specific capabilities. For example, an embedded device application program within IDE 42 may control image capture features of camera 62 using a command communicated via proxy implementation 48 and controller 44 to agent 80, with image data captured by camera 62 communicated back to the application program running on computer 14.

A system and method for providing hardware sensor data and mobile device functionality to a development environment according to the present disclosure have many applications. For example, an embedded device game developed within IDE 42 can use actual sensor data from motion sensor 64 to test the game response to actions performed by a player while having the resources of development computer 14 and IDE 42 for debugging. As another example, a laptop development computer 14 with IDE 42 may be used to develop a mapping application for a mobile embedded device 12 with location sensor 60 providing actual GPS data to the application running within IDE 42. A representative barcode application may be tested using actual data captured from barcode reader 66 rather than simulated input typically provided by typing in barcode data. Use of actual data may reveal programming bugs early in development saving significant debugging time. As yet another example, communications with one or more linked devices 50, 70 associated with mobile device 12 via a wired or wireless protocol, may be tested using the protocol stack on embedded device 12 to reveal any protocol-specific or device-specific limitations much earlier in the development cycle. Although touch sensor input can be simulated by a pointing device, the behavior is different than a finger touch on an actual sensor, such as touch sensor 68. The ability to use actual data associated with sensor 68 within IDE 42 allows development of embedded device applications with improved user experience. Likewise, multi-touch input is difficult to simulate and can usually be tested only after deployment of the application program to the actual device. However, agent 80, proxy implementation 48, and controller 44 allow actual multi-touch data to be provided to IDE 42 for use in development according to the present disclosure.

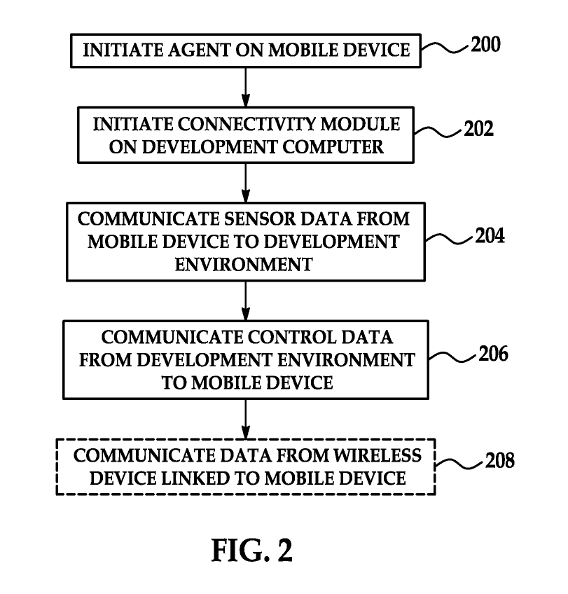

FIG. 2 provides a simplified representation of a system or method for providing sensor data from a mobile device to a development environment according to one embodiment of the present disclosure. A connection or communication agent is initiated on an embedded device as represented by block 200. The agent may acquire sensor data from one or more hardware sensors integrated within, or linked to the embedded device and format the data within a predefined data structure for subsequent communication to a development environment of a development computer. Communication of sensor data may be performed in response to a request initiated by the application program running within the development environment, or may be initiated by the agent on the embedded device. A corresponding connectivity module is initiated within the development environment on a development computer as represented by block 202 to communicate data and/or control information with the agent on the embedded device. Block 204 represents communicating the formatted sensor data associated with at least one physical sensor associated with the embedded device from the agent on the embedded device to the connectivity module running within the software development environment of the development computer. The sensor data is then passed by the connectivity module through a proxy implementation to the mobile device application program running within the development environment of the development computer. The sensor data may be provided by a secondary embedded device or remote sensor linked to the embedded device using a communication protocol stack of the primary embedded device.

As also shown in the embodiment of FIG. 2, the system/method may include communicating control information from the embedded device application program running within the development environment to the embedded device using the connectivity module, proxy implementation and agent as represented by block 206. The control data may be used to control at least one sensor of the embedded device. In one embodiment, control data are communicated to control an embedded camera on a mobile embedded device to capture an image or movie (audio/video) with sensor data representing the captured image or movie communicated to the development environment. Embodiments may also include use of the agent and connectivity module for communicating data from a secondary embedded device, remote sensor, and/or wireless device linked to the primary embedded device to the development environment as represented by block 208.

As such, embodiments according to the present disclosure provide actual sensor data from an embedded device to a development environment on a development computer for use by an embedded device application executing within the development environment. A generic agent operating on the embedded device communicates sensor information from device sensor(s) integrated with, or linked to, the embedded device to the development environment. As previously described, use of an attached embedded device with actual sensor data greatly enhances the ability of the developer to test code within the development environment on the development computer, which may improve productivity and reduce development time while improving the robustness of the application software when deployed to the embedded device. Use of an agent module on the embedded device provides development environment access to sensor output from virtually any type of sensor used in an embedded device capable of accessing sensor data or device functionality using available API's. Embodiments provide a proxy implementation, controller, and agent so that the same API's are used within the development environment as those used on the embedded device.

While various embodiments for providing actual sensor data from a target device to a development environment have been illustrated and described, it is not intended that these embodiments illustrate and describe all possible forms thereof. Indeed, various modifications to the disclosed embodiments will be readily apparent to those skilled in the art. In that regard, the words used in the specification are words of description rather than limitation, and it is understood that various changes may be made and the general principles described herein may be applied to other embodiments and applications without departing from the spirit and scope of the following claims.

What is claimed is:

1. A system for providing sensor data for use by embedded device application software executing within a software development environment on a development computer, the system comprising:
an embedded device having a microprocessor in communication with at least one physical sensor; and
an agent executed by the microprocessor on the embedded device, the agent communicating data associated with the at least one physical sensor to the software development environment.

2. The system of claim 1 wherein the embedded device application software executing within the software development environment on the development computer communicates a command to the agent on the embedded device.

3. The system of claim 1 wherein the embedded device application software executing within the software development environment uses API calls of an intended target embedded device to acquire sensor data within the software development environment from the agent running on the embedded device.

4. The system of claim 1 wherein the embedded device comprises a set top box.

5. The system of claim 1 wherein the embedded device comprises a mobile phone.

6. The system of claim 1 further comprising at least one secondary device having an associated physical sensor, the secondary device in communication with the embedded device, wherein the agent communicates data for the physical sensor associated with the secondary device to the embedded device application software executing within the software development environment on the development computer.

7. The system of claim 6 wherein the at least one secondary device comprises a wireless device communicating with the embedded device using a communication protocol having a protocol stack stored in memory of the embedded device.

8. The method of claim 1 wherein the at least one physical sensor comprises a camera and wherein the data communicated to the software development environment includes data representing images captured by the camera.

9. The system of claim 1 wherein the at least one physical sensor comprises a location sensor and wherein the data communicated to the software development environment includes global position system (GPS) data.

10. The system of claim 1 wherein the software development environment includes a connectivity module that communicates with the agent on the embedded device to send commands from the embedded device application software executing on the development computer within the development environment to the agent and to receive the data associated with the at least one physical sensor from the agent.

11. A method for providing device data for developing embedded device application software on a development computer using a software development environment, the method comprising:
communicating sensor data from an embedded device having a microprocessor in communication with at least one physical sensor associated with the embedded device to the software development environment of the development computer.

12. The method of claim 11 further comprising:
communicating control data from the embedded device application software executing within the software development environment of the development computer to the embedded device.

13. The method of claim 12 wherein the control data controls at least one sensor associated with the embedded device.

14. The method of claim 12 wherein the at least one sensor comprises a camera, wherein communicating sensor data comprises communicating image data captured by the camera, and wherein communicating control data comprises communicating data to control the camera.

15. The method of claim 11 wherein communicating sensor data is triggered by an event detected by the embedded device.

16. The method of claim 11 wherein communicating sensor data comprises communicating sensor data associated with a secondary embedded device linked to the embedded device.

17. The method of claim 11 wherein the embedded device comprises a mobile phone.

18. A computer readable storage medium having stored data representing instructions executable by a microprocessor on an embedded device having at least one physical sensor to communicate with a software development environment on a development computer, the storage medium comprising:
instructions for communicating data associated with the at least one physical sensor of the embedded device to the software development environment on the development computer.

19. The computer readable storage medium of claim 18 further comprising:
instructions for receiving control data for the at least one physical sensor from the software development environment.

20. The computer readable storage medium of claim 18 wherein the instructions for communicating data comprise instructions for communicating data in response to an event detected by the embedded device.
